(19) United States
(12) Patent Application Publication
(10) Pub. No.: US 2008/0000562 A1
(43) Pub. Date: Jan. 3, 2008

(54) Bicycle tire having wear indicator

(75) Inventor: Nai-Chien Mohr, Taipei (TW)

Correspondence Address: BACON & THOMAS, PLLC, 625 SLATERS LANE, FOURTH FLOOR, ALEXANDRIA, VA, 22314, US

(73) Assignee: DEM Inc., Taipei City (TW)

(21) Appl. No.: 11/500,289

(22) Filed: Aug. 8, 2006

(30) Foreign Application Priority Data
Jun. 28, 2006 (TW) 095211318

(51) Int. Cl. B60C 11/24

(52) U.S. Cl. 152/154.2; 152/209.5

(57) ABSTRACT

The present invention is directed to a bicycle tire having a wear indicator. The tire has a plurality of tire ribs distributed on a tread to act as the portion of the tire directly contacting with the ground. The plurality of tire ribs comprise more than one indicative tire rib, and the indicative tire rib has at least one color block layer. When the color block layer is completely worn, it means that the extent of the wear has reached the standard of immediately replacing the tire. In addition, the indicative tire rib can be also provided at such a position that the extent of wear of the tire has reached to an extent of replacing with a new one immediately once the color block layer appears.

### BACKGROUND OF THE INVENTION

1. Field of the Invention

The present invention relates to a bicycle tire, and in particular to a tire having a wear indicator. With the visual observation of the outer surface of the tire, it can be determined whether the wear of the tire has reached an extent of replacing with a new one.

2. Description of Prior Art

In 1845, Thomson got the patent right of the first inflatable tire. Until 1932, one person called Zoma first scribed some tiny patterns on the tread and found that those tread patterns can absorb the water on the road, so that he got the patent right of the tread pattern.

The essential task of the tread pattern is to squeeze the water on the road, so that the tread can generate a good function to tightly grasp the ground when contacting with the ground. However, when the tread pattern is too shallow, in addition to the poor drainage and low grip, the heat generated by the tire cannot be timely dissipated, so that the tire may easily got broken in an emergency brake. Further, when the tread pattern is too shallow, it makes the tread thinner and thus it is easy to be penetrated by sharp articles, resulting in traffic accidents.

Since the tread pattern will gradually disappear due to the wear of the tire, if the extent of wear of the tire is not recognized at peacetime, it is too late to found that the tire has been worn out when the traffic accident happens.

### SUMMARY OF THE INVENTION

After a tire has been used for a period of time, the wear of the tread is inevitably generated. Therefore, when the tire surface has been worn to the extent of replacing, a new tire should be replaced immediately so as to assure the safety in driving.

The primary object of the present invention is to provide a tire having a wear indicator, by which the user can get the information about the wear with the direct observation of the external appearance of the tire. Further, when the tire has already or almost reached the extent of replacing, the user can also get correct information with the visual observation of the external appearance of the tire.

The tire of the present invention is one that more than one indicative tire ribs are provided on the tire tread. When the extent of wear of the tire has already achieved a standard of replacing with a new tire, the indicative tire rib starts to appear the colored surface with a warning color. Therefore, when the surface of the indicative tire rib has been worn to show the warning color, it means that the tire should be replaced as soon as possible or even at once.

In practice, the indicative tire rib has a color block layer showing that the extent of wear is within a safe range. When the color block layer has been completely worn, it means the extent of wear has already reached the extent of replacing a new tire immediately.

Further, the color block layer of the indicative tire rib can be arranged at such a position that the extent of wear of the tire has reached to an extent of replacing with a new one immediately once the color block layer appears.

In addition to this, the indicative tire rib can combine more than two color block layers comprising a first color block layer showing that the extent of wear is still within the safe range and a second color layer showing that the extent of wear has reached the extent of replacing a new tire immediately.

The detailed description and the technical contents relating to the present invention will be made with reference to the accompanying drawings.

### BRIEF DESCRIPTION OF THE DRAWINGS

FIG. 1 is a front view showing that the tire of the present invention is combined with the outer edge of the tire rim;

FIG. 2A is a partially perspective cross-sectional view of the tire of the present invention;

FIG. 2B is a partially perspective cross-sectional view of the tire of the present invention cut at another position;

FIGS. 3A and 3B are schematic views of a first embodiment of the indicative tire rib of the tire of the present invention;

FIGS. 4A and 4B are schematic views of a second embodiment of the indicative tire rib of the tire of the present invention;

FIGS. 5A and 5B are schematic views of a third embodiment of the indicative tire rib of the tire of the present invention; and

FIGS. 6A and 6B are schematic views of a fourth embodiment of the indicative tire rib of the tire of the present invention.

### DETAILED DESCRIPTION OF THE INVENTION

The following embodiments describe the characteristics and advantages of the present invention in detail, so that those skilled in this art can implement the present invention by utilizing the technical content thereof.

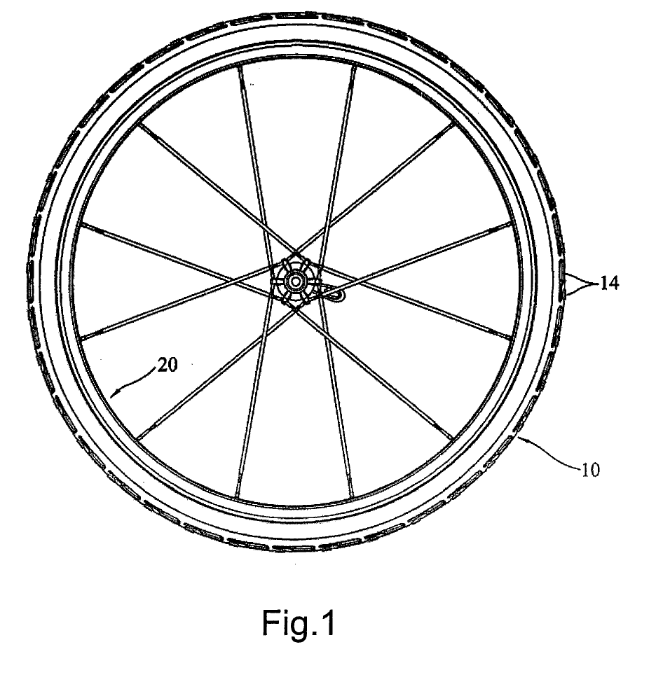

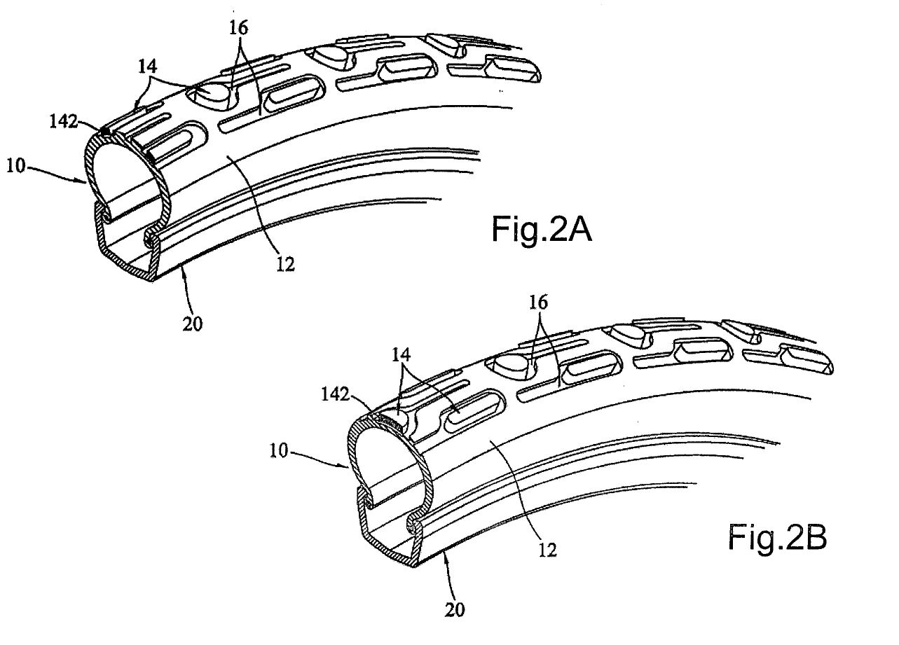

FIG. 1 is a front view showing that the tire of the present invention is combined with the outer edge of the tire rim. FIGS. 2A and 2B are partially perspective cross-sectional views of the tire of the present invention. As shown in the figures, the tire 10 is fixed to cover on the outer edge of the wheel rim 20, and thus the tire becomes the essential member of the bicycle for running on the road. The tire 10 has a plurality of tire ribs 14 distributed on the tread 12 and a tread pattern 16 formed between each tire rib 14. With such arrangement, when the tire 10 runs on the road, the tread pattern 16 can squeeze the water on the road, so that the tread 12 can generate a sufficient friction to grasp the ground when contacting with the ground.

When the tire 10 is running, the tire rib 14 is the portion directly contacting with the ground. Therefore, the tire rib 14 will be gradually worn due to the contact with the ground, so that the thickness of the tire rib becomes thinner and thinner. As the thickness of the tire rib 14 becomes thinner, the depth of the tread pattern 14 will also become shallow. When the depth of the tread pattern 16 is too shallow or completely disappeared, it is likely to seriously affect the safety in driving if the driver does not detect the nearly smooth tread pattern and replace a new tire 10.

In view of the above, the tire 10 disclosed in the present invention has an effect of displaying the extent of wear, so that the user can directly get the information about the wear with the visual observation of the external appearance of the tire 10. When the tire 10 has already or almost reached a wear condition showing that the old tire should be replaced, the user can get clear and correct information about the wear with the observation of the external appearance of the tire 10.

The present invention lies in that the plurality of tire ribs 14 circumferentially distributed in the center and on both sides of the tread 12 are provided with indicative tire ribs 14 combining with a color block layer 142. The color block layer 142 is made of colored material having a shining color different from that of the tread 12. With the color block layer 142, the information about the wear of the tire can be provided.

For carrying out the present invention, several best modes can be adopted and their descriptions are as follows.

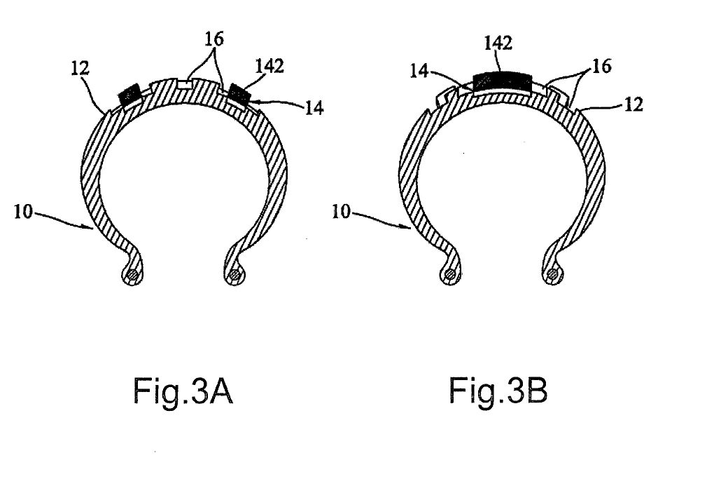

With reference to FIG. 3A and FIG. 3B showing the cross-sectional views taken from different sections of the tire, if all the tire ribs 14 provided in the center and on both sides of the tread 12 are the indicative tire ribs 14, the distal end of each indicative tire rib 14 is provided with a color block layer 142. The colored surface of the color block layer 142 is different form that of the tread 12. For example, if the tread 12 is black, the color block layer 142 can adopt a color other than the black. The thickness of the color block layer 142 can extend downwardly to the lowest position at which the extent of wear of the indicative tire rib 14 is within the safe range.

If the indicative tire rib 14 has a “green” color block layer representing a safe color, when the indicative tire rib 14 on the tire 10 maintains to show the green surface, it means the depth of the tread pattern 16 is still sufficient to perform the normal function. The user can easily and correctly determiner whether the extent of the wear of the tire 10 is within the safe range with the visual observation of the external appearance of the tire 10.

In other words, when the green color block layer 142 on the tire rib 14 is completely worn, it's time to replace the tire 10.

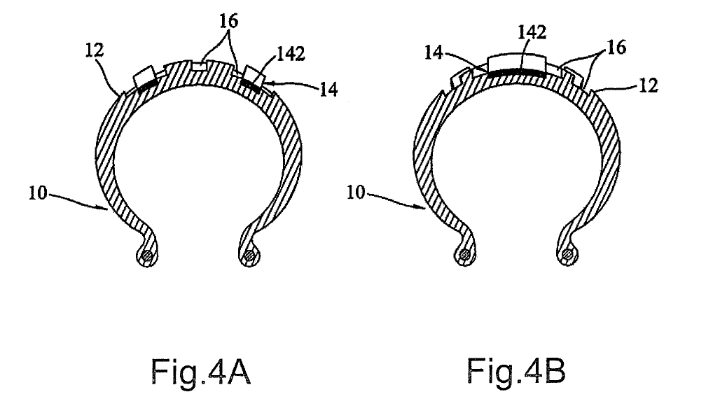

With reference to FIG. 4A and FIG. 4B, the color block layer 142 provided on the indicative tire rib 14 is located near the root. The colored surface of the color block layer 142 is different form that of the tread 12. For example, if the tread 12 is black, the color block layer 142 can adopt a color other than black.

If the indicative tire rib 14 has a “red” color block layer 142 representing a warning color, as long as the indicative rib 14 of the tire 10 does not appear the red surface yet, it means the depth of the tread pattern 16 is still sufficient to perform the normal function. The user can easily and correctly determiner whether the extent of the wear of the tire 10 is within the safe range with the visual observation of the external appearance of the tire 10.

In other words, when the tire rib 14 is gradually worn and the red color block layer 142 starts to appear, the user should replace with a new tire 10 once finding the appearance of the color block layer 142.

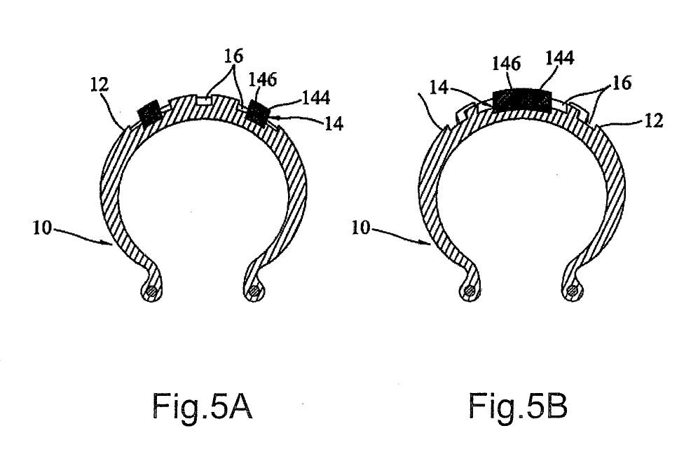

FIG. 5A and FIG. 5B show another embodiment of the tire rib of the present invention. As shown in the figures, the indicative rib 14 are constituted of more than two color block layers 144, 146 comprising a first color block layer 144 showing that the extent of wear is within a safe range and a second color block layer 146 showing that the extent of wear has reached the standard of replacing with a new tire.

The colored surfaces of the first color block layer 144 and the second color block layer 146 are different form that of the tread 12. For example, if the tread 12 is black, the first color block layer 144 and the second color block layer 146 can adopt a color other than black.

Supposed that the tire rib 14 has the “green” first color block layer 144 representing the safe color and the “red” second color block layer 146 representing the warning color, when the surface of the tire rib 14 maintains to show a green surface, it means that the depth of the tread pattern 16 is still sufficient to perform the normal function. However, if the surface of the tire rib 14 starts to show the red surface, it's time to replace with a new tire immediately.

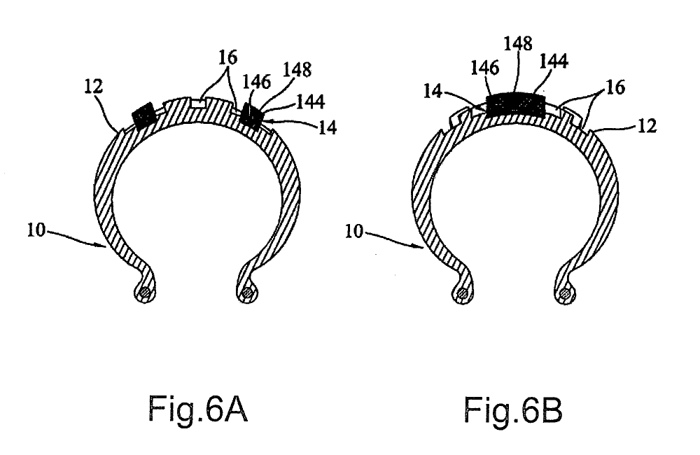

As shown in FIGS. 6A and 6B, when the indicative tire rib 14 constituted of a plurality of color block layers is in practice, a third color block layer 148 can be further provided between the first color block layer 144 and the second color block layer 146. The third color block layer 148 is used to show that the indicative tire rib 14 is worn to an extent of necessarily replacing with a new tire. The colored surface of the third color block layer 148 is different form those of the first color block layer 144 and the second color block layer 146. If the first color block layer 144 and the second color block layer 146 are green and red, and the tread 12 is black, the third color block layer 148 can adopt the color other than green, red and black, such as yellow.

With the above arrangement, when the first color block layer 144 of the indicative tire rib is completely worn, the second color block layer 146 representing the immediate replacement of tire will not directly appear, but the third color block layer 148 firstly appears to show that the tire is almost worn to an extent of replacement. Therefore, with the appearance of the third color block layer 148, the user can understand that the tire 10 should be replaced soon.

According to the above, with the provision of the color block indicator on the tire to show the wear condition, the present invention can provide the information about the wear of the tire. Although the present invention has been described with reference to the foregoing preferred embodiments, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A bicycle tire having a wear indicator, the tire having a plurality of tire ribs distributed on a tread to act as the portion of the tire directly contacting with the ground, characterized in that the tire ribs comprise more than one indicative tire rib, and the indicative tire rib has a color block layer showing that the extent of wear is within a safe range.

2. The bicycle tire having a wear indicator according to claim 1, wherein the colored surface of the color block layer is different form that of the tread.

3. The bicycle tire having a wear indicator according to claim 1, wherein the color of the color block layer is a safe color.

4. A bicycle tire having a wear indicator, the tire having a plurality of tire ribs distributed on a tread to act as the portion of the tire directly contacting with the ground, characterized in that the tire ribs comprise more than one indicative tire rib, and the indicative tire rib has a color block layer showing that the extent of wear has reached a standard of replacing the tire.

5. The bicycle tire having a wear indicator according to claim 4, wherein the colored surface of the color block layer is different form that of the tread.

6. The bicycle tire having a wear indicator according to claim 4, wherein the color of the color block layer is a warning color.

7. A bicycle tire having a wear indicator, the tire having a plurality of tire ribs distributed on a tread to act as the portion of the tire directly contacting with the ground, characterized in that the tire ribs comprise more than one indicative tire ribs, and the indicative tire rib has a fist color block layer showing that the extent of wear is within a safe range and a second color block layer showing that the extent of wear has reached a standard of replacing the tire.

8. The bicycle tire having a wear indicator according to claim 7, wherein the colored surfaces of the first color block layer and the second color block layer are different form each other.

9. The bicycle tire having a wear indicator according to claim 7, wherein the colored surfaces of the first color block layer and the second color block layer are different form that of the tread.

10. The bicycle tire having a wear indicator according to claim 7, wherein the color of the first color block layer is a safe color and the color of the second color block layer is a warning color.

11. The bicycle tire having a wear indicator according to claim 7, wherein a third color block layer is provided between the first color block layer and the second color block layer for showing that the extent of wear has almost reached the standard of replacing the tire.

12. The bicycle tire having a wear indicator according to claim 11, wherein the colored surface of the third color block layer is different from those of the first color block layer and the second color block layer.
